(19) United States
(12) Patent Application Publication
(10) Pub. No.: US 2010/0194674 A1
(43) Pub. Date: Aug. 5, 2010

(54) LIQUID CRYSTAL DISPLAY DEVICE

(76) Inventors: Yusuke Nishihara, Osaka (JP); Masumi Kubo, Osaka (JP); Tokio Taguchi, Osaka (JP); Kenji Okamoto, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/678,434

(22) PCT Filed: Aug. 27, 2008
(86) PCT No.: PCT/JP2008/065326

§ 371 Date: Mar. 16, 2010

(30) Foreign Application Priority Data
Dec. 14, 2007 (JP) 2007-323767

(51) Int. Cl. G09G 3/36

(52) U.S. Cl. 345/102

(57) ABSTRACT

The liquid crystal display device (1) of the present invention includes a liquid crystal display panel (3) and a backlight (2). In the backlight (2), a plurality of plasma tubes (22) are employed as light sources. The backlight (2) includes: a substrate (21) and; an array structure (23) in which the plurality of plasma tubes (22) are provided, in an array, on the substrate (21). A surface of the array structure (23) opposite to a surface facing the substrate (21) serves as a light emitting section (29) that irradiates the liquid crystal display panel (3). Since the backlight includes plasma tubes serving as the light sources, it is possible to achieve a thinner liquid crystal display device that carries out a high-definition image display in spite of its thin thickness.

### TECHNICAL FIELD

The present invention relates to a liquid crystal display device. The present invention particularly relates to a liquid crystal display device employing plasma tubes as a backlight.

### BACKGROUND ART

A liquid crystal display device has become rapidly widespread recently in place of a cathode ray tube (CRT) display device. Such a liquid crystal display device is for widely use in an electronic device such as a liquid crystal display television, a monitor, or a mobile phone, because the liquid crystal display device has the advantages that it is energy-saving, thin, and light. It is possible to further put such advantages to good use by, for example, improving a backlight, which is provided behind the liquid crystal display device.

The backlight is broadly classified into a side backlight (also called “edge backlight”) and a direct backlight. The side backlight is arranged such that (i) a light guide member is provided behind a liquid crystal display panel and (ii) a light source such as a fluorescent lamp (e.g., Cold Cathode Fluorescent Lamp or LED) is provided on a lateral end of the light guide member. Such a side backlight uniformly irradiates the liquid crystal display panel as follows. The light emitted from the light source is propagated in the light guide member, and is then directed toward the liquid crystal display panel. According to the arrangement, it is possible to achieve a thinner backlight that is excellent in uniformity of luminance. Because of its excellent uniformity of luminance, the side backlight is mainly employed in a medium-small size liquid crystal display for use in a device such as a mobile phone or a laptop computer. However, in a case of a larger liquid crystal display panel, such an arrangement, in which the light source is provided on the lateral end of the light guide member, causes light not to fully reach regions far away from the light source. This allows a target luminance not to be achieved and/or this causes luminance unevenness. In view of the circumstances, it is the direct backlight that is suitably used in a large liquid crystal display panel.

The direct backlight, in which a plurality of light sources, such as those described earlier, are provided behind the liquid crystal panel so as to directly irradiate the liquid crystal panel. The direct backlight thus easily achieves high luminance even in a case where it is used in a large display.

Therefore, the direct backlight is mainly employed in a liquid crystal display that is as large as 20 inches or more. Patent Literature 1 discloses one example of the direct backlight, which includes (1) light emitting diodes each serving as a light source and (ii) a diffuser, provided above the light emitting diodes, for directing light toward the liquid crystal display.

### CITATION LIST

Patent Literature 1

Japanese Patent Application Publication, Tokukai, No. 2005-115372 A (Publication Date: Apr. 28, 2005)

Patent Literature 2

Japanese Patent Application Publication, Tokukai, No. 2003-338244 A (Publication Date: Nov. 28, 2003)

Patent Literature 3

Japanese Patent Application Publication, Tokukai, No. 2003-86141 A (Publication Date: Mar. 20, 2003)

Patent Literature 4

Japanese Patent Application Publication, Tokukai, No. 2003-92085 A (Publication Date: Mar. 28, 2003)

### SUMMARY OF INVENTION

However, a conventional direct backlight is generally as thick as approximately 20 mm to 40 mm. This makes it difficult to achieve a thinner liquid crystal display. This is because it is necessary to further provide members such as a diffusing plate having a certain degree of thickness between the plurality of light sources and a liquid crystal display panel so that the liquid crystal display panel is uniformly irradiated with the light emitted from the plurality of light sources provided behind the liquid crystal display panel. In case of reducing, under the circumstances, a thickness of the diffusing plate so that a thinner liquid crystal display is achieved, the uniformity of luminance will no longer be achieved.

In view of the circumstances, a thinner backlight, which achieves high luminance and is excellent in uniformity of luminance in spite of its thin thickness, is desired to be developed for use particularly in a large liquid crystal display panel.

Meanwhile, Patent Literatures 2 through 4 propose an arrangement as means for carrying out an image display, in which arrangement gas electric discharge tubes (plasma tubes), each having a thin tube shape, are provided in an array. For example, Patent Literature 2 discloses a luminous tube-array display device, which includes (i) a luminous tube array in which a plurality of luminous tubes (plasma tubes) are provided in an array, each of the plurality of luminous tubes being a thin tube inside of which a fluorescent layer is provided and in which electric discharge gas is encapsulated, (ii) data electrodes which are provided under the plurality of luminous tubes in a longitudinal direction of the plurality of luminous tubes, and (iii) display electrodes which are provided on the plurality of luminous tubes so that they intersect with the data electrodes.

Intersections of the data electrodes and the display electrodes serve as respective unit light-emitting regions. A display is carried out by (i) using one of a pair of display electrodes as a scanning electrode, (ii) generating a selective electric discharge at an intersection of the scanning electrode and a corresponding one of the data electrodes so that ultraviolet radiation is emitted inside a corresponding one of the plurality of luminous tubes, and then (iii) causing the ultraviolet radiation to excite a fluorescent material provided on a surface in the corresponding one of the plurality of luminous tubes of the intersection so that visible light is emitted. The display is thus carried out.

However, the current state of art causes each of the plasma tubes to have a thickness of not less than 1 mm. It follows that each of the unit light-emitting regions has a size of not less than 1 mm×1 mm. Under the circumstances, a display device employing plasma tubes is indeed suitable for use in a large screen device, whereas it is practically unsuitable for use in display devices, which are required to carry out a high-definition image display, such as a television and a personal computer.

In view of the circumstances, the present invention achieves a thinner liquid crystal display device that displays a high-definition image in spite of its thin thickness, by employing plasma tubes, like the above ones, as light sources of a backlight.

In order to attain the object, a liquid crystal display device, including a liquid crystal display panel and a backlight, the backlight including a plurality of plasma tubes serving as light sources, in each of the plasma tubes (i) a fluorescent material being included and (ii) electric discharge gas being encapsulated, and the plurality of plasma tubes being provided behind the liquid crystal display panel.

The liquid crystal display device of the present invention employs the plurality of plasma tubes serving as the light sources of the backlight. Each of the plurality of plasma tubes has a diameter that (i) falls within a range of approximately 1 mm to 5 mm and (ii) is smaller than that of a fluorescent lamp which has conventionally been used as a light source. Therefore, even in a case where the light sources are provided behind the liquid crystal display panel (that is, on an opposite surface side of an image display surface), it is still possible to achieve a thin backlight. According to the arrangement, since the light sources are provided behind the liquid crystal display panel, it is possible to achieve a thinner liquid crystal display device in which the liquid crystal display panel is irradiated with light of high luminance.

The conventional technique has employed, in a display device, plasma tubes as light emitting materials. In such a case, however, a size of each pixel depends on a diameter (approximately 1 mm to 5 mm) of the plasma tubes. This causes inferiority in display fineness as compared to other display devices. In contrast, according to the present invention, plasma tubes serve as light sources of a backlight. As such, it is possible to keep display fineness at least as good as that of a conventional display device.

The liquid crystal display device is preferably arranged such that the backlight has (i) a substrate and (ii) an array structure in which the plurality of plasma tubes are provided on the substrate; and the array structure has a first surface serving as a light emitting section that irradiates the liquid crystal display panel with light, the first surface being opposite to a second surface which faces the substrate.

According to the arrangement, a surface light source emits light from an entire surface of the array structure in which the plurality of plasma tubes are provided in an array. As such, it is possible to irradiate an entire surface of the liquid crystal panel with uniform light. Further, there is no need to provide a diffusing plate having a certain degree of thickness so that the light is uniformly diffused. This is unlike a liquid crystal display device employing point light sources such as light emitting diodes. Accordingly, it is possible to achieve a thinner backlight as compared to a backlight employing the light emitting diodes serving as the light sources. As such, it is possible to achieve a thinner liquid crystal display device including a backlight with improved uniformity of luminance.

The liquid crystal display device is preferably arranged such that the array structure includes (i) a plurality of first electrodes that are provided in a direction in which the plurality of plasma tubes are provided and (ii) a plurality of second electrodes that are provided so as to intersect with the plurality of plasma tubes; and the plurality of first electrodes and the plurality of second electrodes are provided so as to face each other via the plurality of plasma tubes.

According to the arrangement, an electric potential difference is generated between the plurality of first electrodes and the plurality of second electrodes. As such, it is possible to cause the plurality of plasma tubes to be electrically discharged so that the light is emitted. It is also possible to control intensity of light emission, by controlling the electric potential differences between the plurality of first electrodes and the plurality of second electrodes.

The liquid crystal display device may be arranged such that the plurality of first electrodes are provided so that one (1) first electrode is provided for every at least one plasma tube; and the plurality of second electrodes are provided in an array so as to intersect with the plurality of plasma tubes.

According to the arrangement, it is possible to utilize, as the unit light-emitting regions, intersections of the plurality of first electrodes and the plurality of second electrodes, which are provided via the plurality of plasma tubes. Further, a size of each of the unit light-emitting regions can be changed as appropriate, depending on whether the plurality of first electrodes are provided so that one (1) first electrode is provided for every one (1) plasma tube or so that one (1) first electrode is provided for every plural plasma tubes.

For example, providing one (1) first electrode for every one (1) plasma tube makes it possible to form a unit light-emitting region corresponding to every one (1) plasma tube. On the other hand, providing one (1) first electrode for every plural plasma tubes makes it possible to form a unit light-emitting region corresponding to every plural plasma tubes.

The liquid crystal display device is preferably arranged such that the plurality of first electrodes and the plurality of second electrodes, which are provided so as to (i) intersect with each other and (ii) face each other via the plurality of plasma tubes, form intersections in which respective unit light-emitting regions are provided, said backlight including a drive section that can adjust, for each of the unit light-emitting regions, luminance of the light emitted from the light emitting section.

According to the arrangement, the luminance of light for each of the unit light-emitting regions is controlled in response to luminance of an image to be displayed on the liquid crystal display panel. As such, it is therefore possible to (1) control luminance of light to be emitted by the backlight toward each region of the liquid crystal display panel. It is therefore possible to (1) achieve an image display of higher quality and higher contrast and (ii) control luminance for each unit region that is smaller than a unit region of a conventional liquid crystal display device including an area active backlight (size of each area is some square centimeters) that employs LEDs. This allows a significant improvement in moving image property.

The liquid crystal display device may be arranged such that the plurality of plasma tubes include a plasma tube having a white fluorescent material.

According to the arrangement, it is possible to achieve a backlight that emits white light.

The liquid crystal display device may be arranged such that the plurality of plasma tubes include a plasma tube having a red fluorescent material, a plasma tube having a green fluorescent material, and a plasma tube having a blue fluorescent material.

According to the arrangement, it is possible to achieve a backlight that emits light by use of a combination of plasma tubes that emit light of red, green, and blue. As such, it is possible to control, depending on an intended purpose, colors (light emission spectra) of light emitted by the backlight.

The liquid crystal display device may be arranged such that the backlight has (i) a/the substrate and (ii) an/the array structure in which the plurality of plasma tubes are provided on the substrate; and the array structure has a/the first surface serving as a/the light emitting section that irradiates the liquid crystal display panel with light, the first surface being opposite to a/the second surface which faces the substrate; and the substrate is made of a flexible material.

According to the arrangement, the surface of the substrate is curved through use of the flexibility of the substrate, and then the plurality of plasma tubes are provided in an array along the surface thus curved. This makes it possible to achieve a backlight whose light emitting surface is curved. Further, it is possible to achieve a liquid crystal display device whose image display surface is curved, by arranging the liquid crystal display panel so that the liquid crystal display panel has a shape which is in conformity to the light emitting surface of the backlight.

For a fuller understanding of the nature and advantages of the invention, reference should be made to the ensuing detailed description taken in conjunction with the accompanying drawings.

### BRIEF DESCRIPTION OF DRAWINGS

FIG. 1 is a perspective view illustrating a structure of a backlight included in a liquid crystal display device according to a first embodiment of the present invention.

FIG. 2 is a perspective view schematically illustrating a structure of the liquid crystal display device according to the first embodiment of the present invention.

FIG. 3 is a plan view illustrating a structure of the backlight of FIG. 1.

FIG. 4 is a cross-sectional view taken along the line A-A′ of the backlight of FIG. 2.

FIG. 5 is a perspective view illustrating a structure of a backlight included in a liquid crystal display device according to a second embodiment of the present invention.

FIG. 6 is a plan view illustrating the structure of the backlight of FIG. 5.

FIG. 7 (a) of FIG. 7 is a cross sectional view taken along the line A-A′ of the backlight of FIG. 6. (b) of FIG. 7 is a cross sectional view taken along the line B-B′ of the backlight of FIG. 6.

FIG. 8 is a perspective view illustrating a structure of a backlight included in a liquid crystal display device according to a third embodiment of the present invention.

FIG. 9 is a plan view illustrating the structure of the backlight of FIG. 8.

FIG. 10 is a cross-sectional view taken along the line A-A′ of the backlight of FIG. 9.

FIG. 11 is a perspective view illustrating a structure of a backlight included in a liquid crystal display device according to a forth embodiment of the present invention.

FIG. 12 is a plan view illustrating the structure of the backlight of FIG. 11.

FIG. 13 (a) of FIG. 13 is a cross-sectional view taken along the line A-A′ of the backlight of FIG. 12. (b) of FIG. 13 is a cross-sectional view taken along the line B-B′ of the backlight of FIG. 12.

### EXPLANATION OF REFERENTIAL NUMERALS

1 Liquid Crystal Display Device
2 Backlight
3 Liquid Crystal Display Panel
21 Substrate
22 Plasma Tube (Light Source)
23 Array Structure
24 Lower Electrode (First Electrode)
24b Lower Electrode (First Electrode)
25 Upper Transparent Electrode (Second Electrode)
25a Upper Electrode Pair (Second Electrode)
25b Upper Transparent Electrode (Second Electrode)
25x Electrode
25y Electrode
27 White Fluorescent Layer (Fluorescent Material)
28 Electric Discharge Gas Space
29 Light Emitting Section
32 Backlight
42 Backlight
52 Backlight
R1 through R4 Unit Light-Emitting Regions

### DESCRIPTION OF EMBODIMENTS

### Embodiment 1

One embodiment of the present invention is described below with reference to the attached drawings. However, the present invention is not limited to the embodiment.

The present embodiment describes a liquid crystal display device including, as a light source, a backlight in which plasma tubes are employed. FIG. 2 schematically illustrates a structure of a liquid crystal display device 1 including such a backlight.

As illustrated in FIG. 2, the liquid crystal display device 1 of the present embodiment includes (i) a liquid crystal display panel 3 and (ii) a backlight 2 that is provided behind the liquid crystal display panel 3. The backlight 2 is arranged so as to emit light toward the liquid crystal display panel 3. The arrow A in FIG. 2 indicates a direction in which the light is emitted from the backlight 2. The liquid crystal display device 1 is a transmissive liquid crystal display device in which a display is carried out by transmitting the light emitted from the backlight 2. Note in FIG. 2 that the backlight 2 is illustrated as if it were provided so as to be away from the liquid crystal display panel 3. However, in reality, the backlight 2 is provided so as to be in contact with the liquid crystal display panel 3.

Note that the liquid crystal display panel 3 of the present invention is not particularly limited. As such, it is possible to employ a widely available liquid crystal panel. A display mode of liquid crystal (such as TN and VA) is not limited to a specific one either. The liquid crystal display panel 3 for example includes, although not illustrated, (i) an active matrix substrate on which a plurality of TFTs (thin film transistors) are provided, (ii) a color filter substrate which faces the active matrix substrate, and (iii) a liquid crystal layer that is sandwiched between the active matrix substrate and the color filter substrate and is sealed with a sealing material.

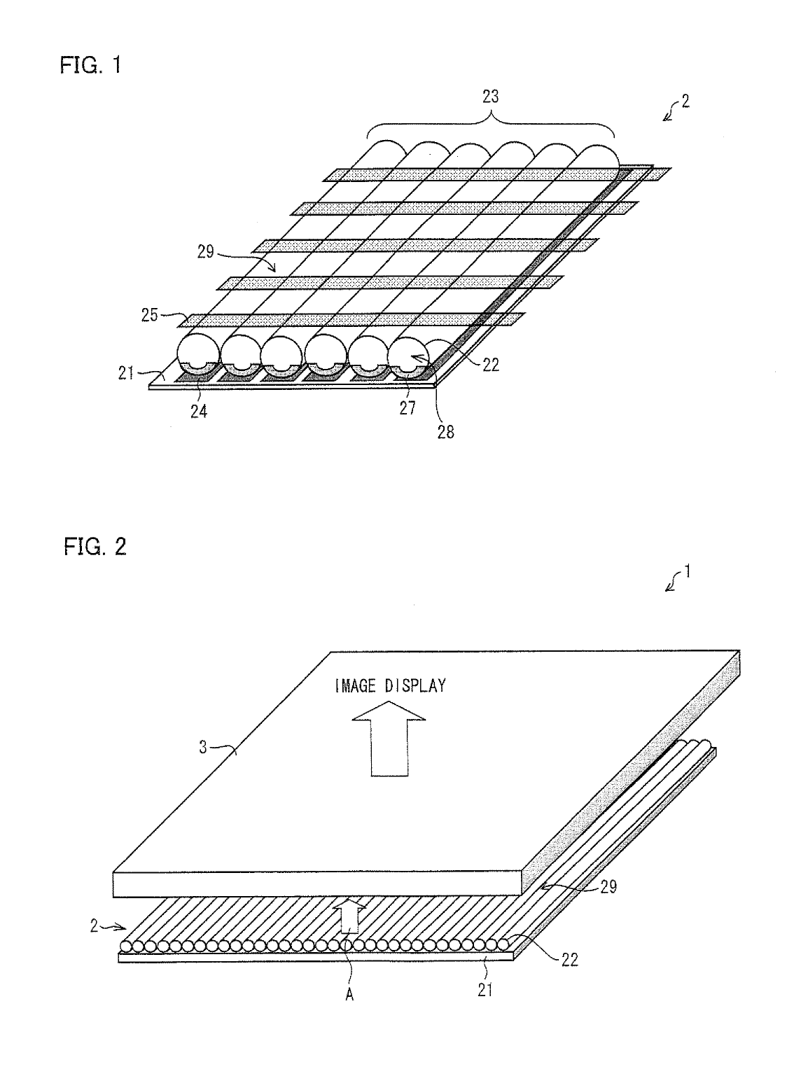

Next, below is a description as to how the backlight 2 is arranged in the liquid crystal display device 2. FIG. 1 illustrates how the backlight 2 is arranged. The backlight 2 of the present embodiment is prepared by making use of, for example, a display device in which plasma tubes (gas discharge tubes) are employed, which display device is disclosed in Patent Literatures 2 through 4.

As illustrated in FIG. 2, the backlight 2 mainly includes: a substrate 21 for supporting plasma tubes; a plurality of plasma tubes 22 (light sources) in each of which electric discharge gas is encapsulated; lower electrodes 24 (first electrodes) for light emission-use each of which are provided between the substrate 21 and the plurality of plasma tubes 22; and upper transparent electrodes 25 (second electrodes) which face the lower electrodes 24 via the plurality of plasma tubes 22. The backlight 2 further includes a transparent substrate (not illustrated) on a light emitting section 29 side.

The substrate 21 is a substrate for supporting plasma tubes, and is made of an insulating material such as plastic or glass.

Each of the plurality of plasma tubes 22 includes a thin tube, made of transparent glass having a diameter of approximately 1 mm to 5 mm, which has an electric discharge gas space 28 in which a white fluorescent layer 27 is provided and electric discharge gas is encapsulated. The plurality of plasma tubes 22 are provided, in an array, on the substrate 21. Such an arrangement in which the plurality of plasma tubes 22 are provided in an array is referred to as an array structure 23.

The lower electrodes 24, each made of a material having electrical conductivity, are provided in a strip manner so as to correspond to the respective plurality of plasma tubes 22. The upper transparent electrodes 25 are made of a transparent electrical conductive film such as ITO, and are provided so as to intersect with the plurality of plasma tubes 22. The lower electrodes 24 and the upper transparent electrodes 25 are provided so as to face each other via the plurality of plasma tubes 22.

In the backlight 2 thus arranged, it is the plurality of plasma tubes 22 that serve as light sources. The liquid crystal display panel 3 is irradiated with the light, emitted in each of the plurality of plasma tubes 22, which has transmitted the transparent substrate (not illustrated). Then, light thus transmitted the transparent substrate irradiates. That is, a surface of the transparent substrate serves as the light emitting section 29 of the backlight 2.

The following description discusses in more detail as to how the array structure 23, in which the plurality of plasma tubes 22 are provided in an array.

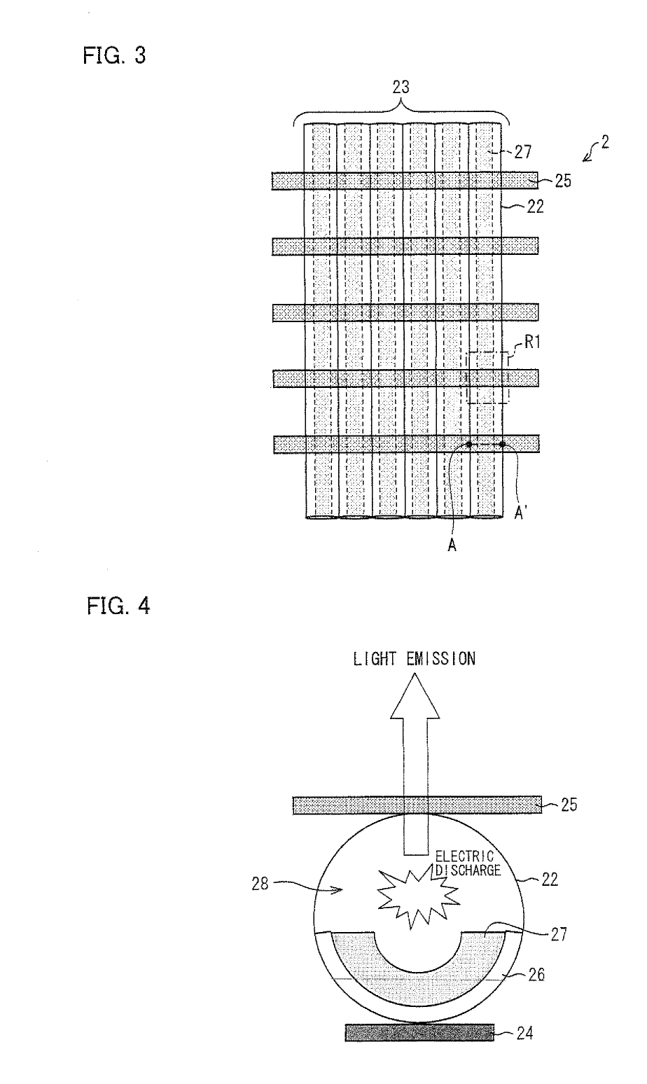

FIG. 3 is a two-dimensional view of the array structure 23 as seen from the light emitting section 29 side (that is, as seen from a side on which the upper transparent electrodes 25 are provided). FIG. 4 is a cross-sectional view taken along the line A-A′ of the array structure 23 of FIG. 3.

As illustrated in FIG. 3, the plurality of plasma tubes 22 are arranged in an array. Further, the lower electrodes 24 (not illustrated), each having a strip shape, are provided in the longitudinal direction of the plurality of the plasma tubes 22, under the plurality of plasma tubes 22 (that is, on a side farther from the liquid crystal display panel 3). Furthermore, on the plurality of plasma tubes 22 (that is, on a side closer to the liquid crystal display panel 3), the upper transparent electrodes 25, each having a strip shape, are provided so as to intersect with the longitudinal direction of the plurality of the plasma tubes 22. The lower electrodes 24 and the upper transparent electrodes 25 are thus provided so as to intersect with each other via the plurality of plasma tubes 22.

Moreover, a support member 26 is provided in each of the plurality of plasma tubes 22 so that the white fluorescent layer 27 is provided on the support member 26 (see FIG. 4). The electric discharge gas is introduced in each of the plurality of plasma tubes 22, and each of the plurality of plasma tubes 22 is end-sealed at both ends. This causes the electric discharge gas space 28 to be formed in each of the plurality of plasma tubes 22.

As described above, according to the present embodiment, the plurality of plasma tubes 22, each having a white fluorescent member and emitting white light, are employed as the light sources. In a case where the plurality of plasma tubes 22, each emitting white light, are employed as the light sources, there is no need to (1) provide the space for color mixture of plural light, (ii) provide a diffusing plate, and/or (iii) increase a haze of a diffusing sheet. This is unlike a case where a combination of plasma tubes, each emitting light of different color, is employed.

However, the present invention is not necessarily limited to such an arrangement in which only the plasma tubes, each emitting white light, are used. For example, the present invention can cover a case where non-predominant plasma tubes, each emitting light of red (R), blue (B), and/or green (G), are inserted into an array of predominant plasma tubes each emitting white light (W) (that is, for example, an array of plasma tubes of WWWWWRWWWWWRWWWWW).

In each of the plurality of plasma tubes 22, electric discharge occurs around each of the intersections of the lower electrodes 24 and the upper transparent electrodes 25 in response to voltages applied between one of the lower electrodes 24 and corresponding ones of the upper transparent electrodes 25 (see FIG. 3, which is a two-dimensional view of the backlight 2 as seen from above). In this way, each of the plurality of plasma tubes 22 emits light. The light thus emitted from inside each of the plurality of plasma tubes 22 transmits a corresponding one of the upper transparent electrodes 25, and is then directed from the light emitting section 29 toward the liquid crystal display panel 3 (see FIG. 4).

As described above, the backlight 2 of Embodiment 1 is arranged such that the electric discharge occurs inside each of the plurality of plasma tubes 22 in each of regions between the lower electrodes 24 and the upper transparent electrodes 25 (that is, the electric discharge occurs directly below each of the upper transparent electrodes 25). As such, unit light-emitting regions R1 correspond to the respective intersections of the lower electrodes 24 and the upper transparent electrodes 25 (see a region indicated by dashed square in FIG. 3) which are provided so as to intersect with each other in a lattice manner. For example, in a case of using plasma tubes each having a diameter of 1 mm, a size of each of the unit light-emitting regions R1 is to be 1 mm×1 mm.

Under the circumstances, it is possible to control light-emitting states of the respective unit light-emitting regions R1, in a case where (i) ones of the lower electrodes 24 and the upper transparent electrodes 25 serve as scanning electrodes and (ii) the other ones of the lower electrodes 24 and the upper transparent electrodes 25 serve as signal electrodes for controlling voltages to be applied between one of the lower electrodes 24 and the upper transparent electrodes 25.

More specifically, it is possible to adjust luminance of light emitted from each of the unit light-emitting regions R1, in a case where the backlight 2 includes a drive circuit (drive section) that is capable of controlling, for the respective unit light-emitting regions R1, voltages to be applied between the lower electrodes 24 and the upper transparent electrodes 25. This makes it possible to achieve an area active backlight. Note that the drive circuit can drive for each area, for example, by employing a display drive for each pixel, which display device is carried out by a display drive circuit included in a conventional display device that employs plasma tubes.

The present embodiment is described based on an example of a backlight employing, as light sources, plasma tubes each emitting white light. However, the present invention is not limited to such an arrangement. For example, the present invention can also be arranged such that plasma tubes emitting light of red (R), green (G), and blue (B) (that is, a combination of plasma tubes each having a fluorescent layer of red, green and blue) are combined. In such a case where the plasma tubes emitting light of R, G, and B are combined, the ratios of the respective plasma tubes emitting light of R, G, and B can be identical. Alternatively, the ratios of the respective plasma tubes emitting light of R, G, and B can be different from one another. For example, in a case where a backlight having a high Y value is desired (generally, luminance is defined by Y value), the number of plasma tubes emitting light of G may be increased, as is represented by RGBGRGBG. It is possible to increase luminance (in this case, luminance is Y value) by increasing the ratio of the plasma tubes emitting light of G.

It should be noted that other embodiments (later described) can also employ, as a light source, a combination of plasma tubes emitting light of red (R), green (G), and blue (B), instead of plasma tubes emitting white light.

Further, a diffusing sheet can be provided between the liquid crystal display panel and the backlight. According to such an arrangement, it is possible to diffuse the light emitted by the backlight so that light thus diffused irradiate the liquid crystal display panel. As such, it is possible to achieve more uniform luminance.

Further, the backlight of the present invention has an array structure in which a plurality of thin tubes are arranged in an array. Therefore, according to the present invention, it is also possible to achieve a backlight whose light emitting surface is curved, because (i) the substrate for supporting the array structure is made of a flexible material (a material having flexibility) and (ii) the thin tubes are arranged on the substrate in a devised manner. More specifically, it is possible for the backlight to have a curved light emitting surface, by causing a surface of the substrate to be curved, and then by arranging a plurality of plasma tubes along the surface thus curved. In a case where the liquid crystal display panel is formed along the curved surface of the backlight, it is possible to achieve a liquid crystal display device whose image display surface is curved.

According to the present embodiment, the backlight is constituted by plasma tubes, each having a circular cross-section. Note, however, that the shape of each of the plasma tubes is not limited to such a shape. For example, each of the plasma tubes can have cross-sections such as a square cross-section, a triangular cross-section, and an oval cross-section.

Note also that the structure of each of the plasma tubes (gas electric discharge tubes) that are to be used in the backlight of the present invention is not limited to the foregoing structure. Therefore, it is possible to employ a structure of another plasma tube (for example, a plasma tube (a light emitting tube) for use in a display apparatus, which plasma tube is disclosed in Patent Literatures 2 through 4).

### Embodiment 2

The second embodiment of the present invention is described below with reference to the attached drawings.

The first embodiment described a liquid crystal display device including a backlight, in which electric discharge occurs, directly below the upper transparent electrodes 25 in the plasma tubes 22, in response to voltages applied between the lower electrodes 24 and the upper transparent electrodes 25. On the other hand, the second embodiment will describe a liquid crystal display device including a backlight, in which (a) electrodes provided on a light emitting section 29 side of the plurality of plasma tubes 22 constitute electrode pairs 25a (each of which is constituted by a pair of electrodes 25x and 25y) and (b) electric discharge occurs in response to voltages applied between each of the electrode pairs 25a and the lower electrodes 24.

A liquid crystal display device 1 of the present embodiment has an arrangement similar to that of the liquid crystal display device 1 of FIG. 2. Therefore, a description of the liquid crystal display 1 of the present embodiment is omitted here. It should be noted in the following descriptions that members having structures similar to those of the liquid crystal display device 1 of Embodiment 1 are given the same reference numerals, and descriptions of the members are omitted as appropriate.

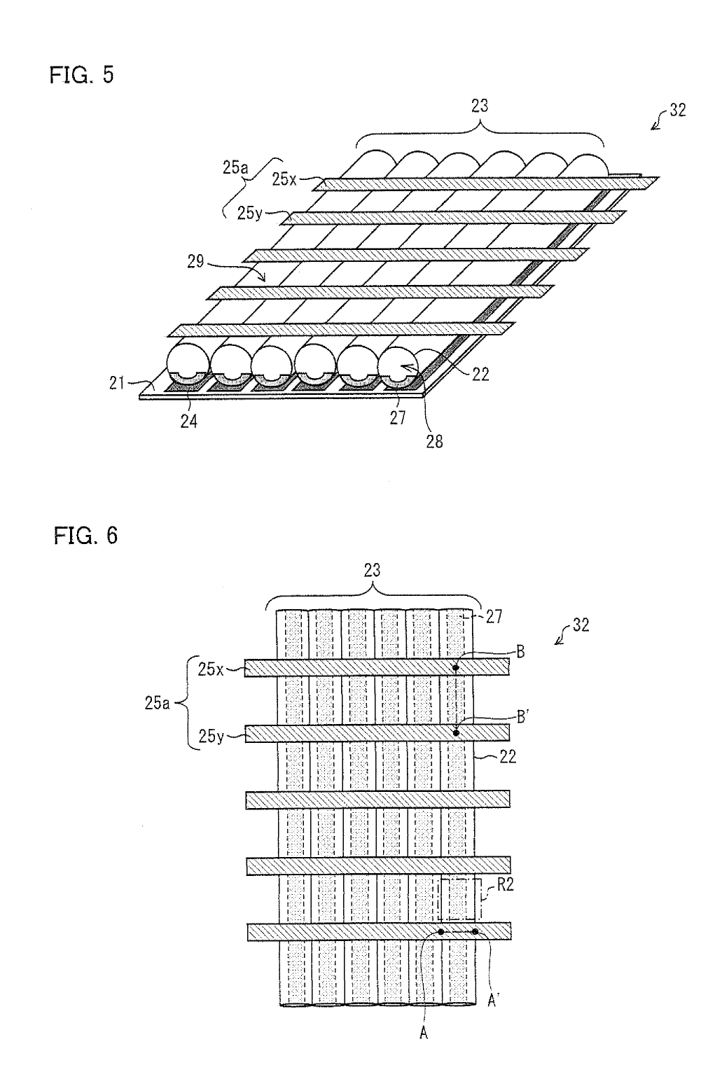

Next, a backlight 32 included in the liquid crystal display device 1 of Embodiment 2 is described below. FIG. 5 illustrates how the backlight 32 is arranged.

As illustrated in FIG. 5, the backlight 32 mainly includes: a substrate 21 for supporting plasma tubes; a plurality of plasma tubes 22 (light sources) in each of which electric discharge gas is encapsulated; lower electrodes 24 (first electrodes) for light emission-use each of which are provided between the substrate 21 and the plurality of plasma tubes 22; and upper electrode pairs 25a (second electrodes) which, face the lower electrodes 24 via the plurality of plasma tubes 22. The backlight 32 further includes a transparent substrate (not illustrated) on a light emitting section 29 side.

Each of the plurality of plasma tubes 22 includes a thin tube, made of transparent glass having a diameter of approximately 1 mm to 5 mm, which has an electric discharge gas space 28 in which a white fluorescent layer 27 is provided and electric discharge gas is encapsulated. The electric discharge gas space 28 is a space inside the small tube, in which electric discharge gas is encapsulated. As is the case with the backlight 2 of Embodiment 1, the plurality of plasma tubes 22 are provided, in an array, on the substrate 21 so as to form an array structure 23. The lower electrodes 24, each made of a material having electrical conductivity, are provided in a strip manner so as to correspond to the respective plurality of plasma tubes 22.

Each of the upper electrode pairs 25a provided on the light emitting section 29 side is constituted by two electrodes, i.e., the electrode 25x and electrode 25y each having a strip shape. The upper transparent electrodes 25 of Embodiment 1, provided on the light emitting section 29 side, are made of a transparent conducting layer such as ITO. However, the upper electrode pairs 25a of Embodiment 2 are not necessarily made of a transparent material and is therefore not limited to a specific one, provided that they are made of a material which has electrical conductivity and are commonly used as a raw material of an electrode. The upper electrode pairs 25a are provided so as to intersect with the plurality of plasma tubes 22. The lower electrodes 24 and the upper electrode pairs 25a are provided so as to face each other via the plurality of plasma tubes 22.

In the backlight 32 thus arranged, it is the plurality of plasma tubes 22 that serve as the light sources. The liquid crystal display panel 3 is irradiated with the light, emitted in each of the plurality of plasma tubes 22, which has transmitted the transparent substrate (not illustrated). Then, light thus transmitted the transparent substrate irradiates. That is, a surface of the transparent substrate serves as the light emitting section 29 of the backlight 32.

Next, the following description discusses, in more detail, the array structure 23 in which the plurality of plasma tubes 22 are provided in an array.

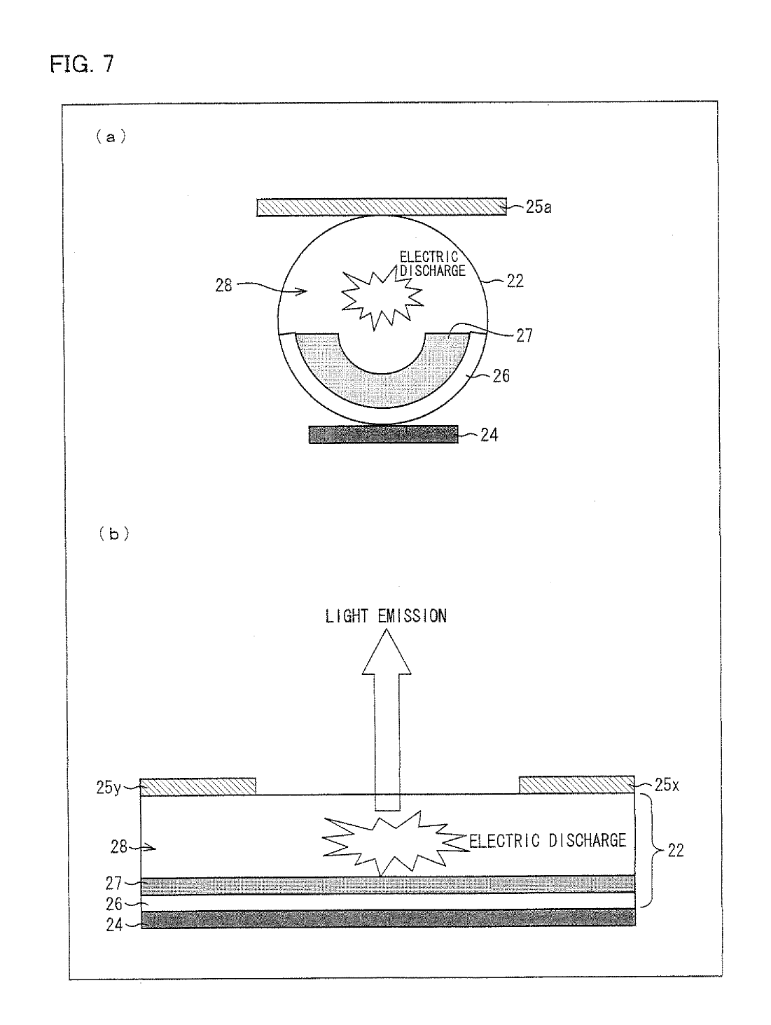

FIG. 6 is a two-dimensional view of the array structure 23 as seen from the light emitting section 29 side (that is, as seen from a direction in which upper electrode pairs 25a are provided). (a) of FIG. 7 is a cross-sectional view taken along the line A-A′ of the array structure 23 of FIG. 6. (b) of FIG. 7 is a cross-sectional view taken along the line B-B′ of the array structure 23 of FIG. 6.

As illustrated in FIG. 6, the plurality of plasma tubes 22 are arranged in an array. Further, the lower electrodes 24 (not illustrated), each having a strip shape, are provided in the longitudinal direction of the plurality of the plasma tubes 22, under the plurality of plasma tubes 22 (that is, on a side farther from the liquid crystal display panel 3). Furthermore, on the plurality of plasma tubes 22 (that is, on a side closer to the liquid crystal display panel 3), the upper electrode pairs 25a, each of which is constituted by the electrode 25x and the electrode 25y, are provided so as to intersect with the longitudinal direction of the plurality of the plasma tubes 22. The lower electrodes 24 and the upper electrode pairs 25a are thus provided so as to intersect with each other via the plurality of plasma tubes 22.

Moreover, a support member 26 is provided in each of the plurality of plasma tubes 22 so that the white fluorescent layer 27 is provided on the support member 26 (see (a) of FIG. 7). The electric discharge gas is introduced in each of the plurality of plasma tubes 22, and each of the plurality of plasma tubes 22 is end-sealed at both ends. This causes the electric discharged gas space 28 to be formed in each of the plurality of plasma tubes 22. As described above, according to the present embodiment, the plurality of plasma tubes 22, each having a white fluorescent member and emitting white light, are employed as the light sources.

As illustrated in (a) and (b) of FIG. 7, the backlight 32 of Embodiment 2 is arranged such that electric discharge occurs, in each of the plurality of plasma tubes 22, (i) between a corresponding one of the upper electrode pairs 25a and a corresponding one of the lower electrodes 24 and (ii) between electrodes 25x and 25y which constitute the upper electrode pairs 25a.

According to the above-described arrangement, in each of the plurality of plasma tubes 22, electric discharge occurs, in response to voltages applied between one of the lower electrodes 24 and corresponding ones of the upper electrode pairs 25a, around regions where (i) the corresponding one of the lower electrodes 24 and (ii) corresponding gaps between the electrodes 25x and the electrodes 25y of the upper electrode pairs 25a intersect with each other (see FIG. 6, which is a two-dimensional view of the backlight 2 as seen from above). In this way, the plurality of plasma tubes 22 emit light. The light thus emitted in each of the plurality of plasma tubes 22 transmits the gaps between the electrodes 25x and the electrodes 25y which constitute the upper electrode pairs 25a, and is then directed from the light emitting section 29 toward the liquid crystal display panel 3 (see (b) of FIG. 7).

According to the above arrangement, it is possible to control light-emitting states of the respective unit light-emitting regions R2, in a case where (i) a pair of electrodes 25x and 25y constituting each of the upper electrodes 25x serve as scanning electrodes and (ii) the lower electrodes 24 serve as signal electrodes for controlling voltages to be applied between the lower electrodes 24 and the upper electrode pairs 25a. In such a case, the unit light-emitting regions R2 correspond to respective regions, one of which is indicated by dashed square in FIG. 6. For example, in a case of using plasma tubes each having a diameter of 1 mm, a size of each of the unit light-emitting regions R2 is to be 1 mm×1 mm.

Further, it is possible to control luminance of light emitted from each of the unit light-emitting regions R2, in a case where the backlight 2 includes a drive circuit (drive section) that is capable of controlling, for the respective unit light-emitting regions R2, voltages to be applied between the lower electrodes 24 and the upper electrode pairs 25a. This makes it possible to achieve an area active backlight.

The following description specifically discusses how to control emission of light for each of the unit light-emitting regions R2.

A display is carried out by (i) using a pair of electrodes 25x and 25y that constitute each of the upper electrode pairs 25a as a scanning electrode, (ii) generating a selective electric discharge at an intersection of the scanning electrode and a corresponding one of the data electrodes (lower electrodes 24) so that ultraviolet radiation is emitted inside a corresponding one of the plurality of luminous tubes, and then (iii) causing the ultraviolet radiation to excite a fluorescent material provided on a surface in the corresponding one of the plurality of luminous tubes of the intersection so that visible light is emitted. The display is thus carried out. The intensity (luminance) of the visible light thus emitted is controlled by changing voltages according to signals that are transmitted to the data electrodes.

### Embodiment 3

The third embodiment of the present invention is described below with reference to the attached drawings.

The first and second embodiments described a liquid crystal display device including a backlight that is arranged such that the lower electrodes 24, which are provided between the substrate 21 and the plurality of plasma tubes 22, are provided for the respective plurality of plasma tubes 22. In contrast, the third embodiment will describe a liquid crystal display device including a backlight that is arranged such that a lower electrode is provided for every predetermined number of plasma tubes (for example, for every three plasma tubes).

A liquid crystal display device 1 of the present embodiment has an arrangement similar to that of the liquid crystal display device 1 of FIG. 2. Therefore, a description of the liquid crystal display 1 of the present embodiment is omitted here. It should be noted in the following descriptions that members having structures similar to those of the liquid crystal display device 1 of Embodiment 1 are given the same reference numerals, and descriptions of the members are omitted as appropriate.

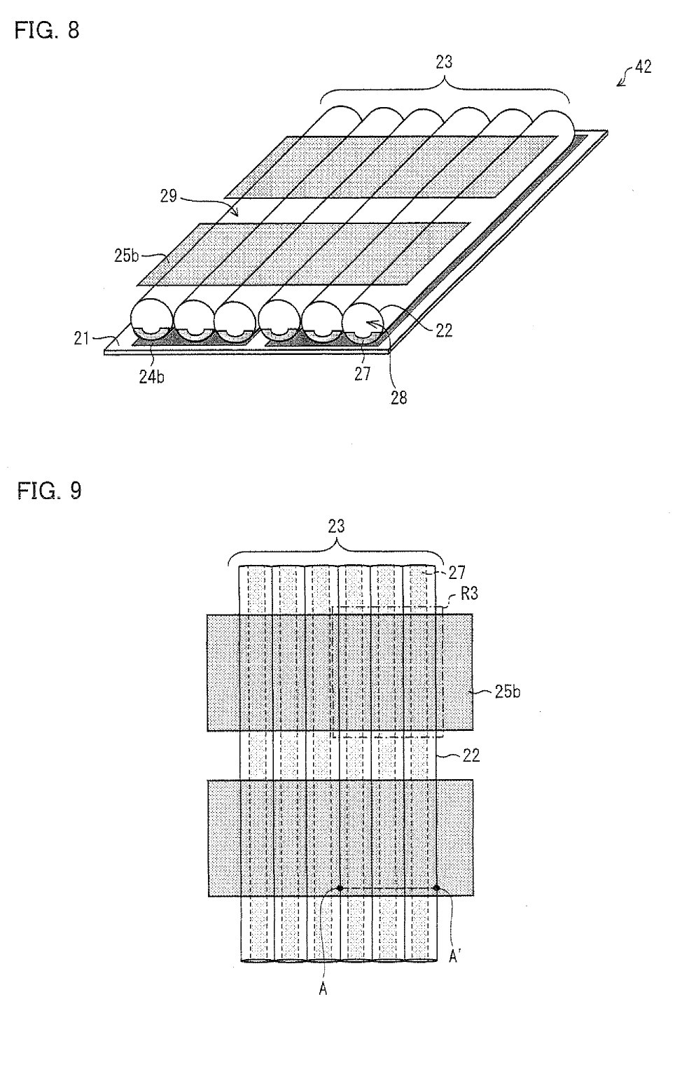

Next, the following description will discuss an arrangement of a backlight 42 included in the liquid crystal display device 1 of Embodiment 3. FIG. 8 illustrates how the backlight 42 is arranged.

As illustrated in FIG. 8, the backlight 42 mainly includes: a substrate 21 for supporting plasma tubes; a plurality of plasma tubes 22 (light sources) in each of which electric discharge gas is encapsulated; lower electrodes 24b (first electrodes) for light emission-use each of which are provided between the substrate 21 and the plurality of plasma tubes 22; and upper transparent electrodes 25b (second electrodes) which face the lower electrodes 24b via the plurality of plasma tubes 22. The backlight 42 further includes a transparent substrate (not illustrated) on a light emitting section 29 side.

Each of the plurality of plasma tubes 22 includes a thin tube, made of transparent glass having a diameter of approximately 1 mm to 5 mm, which has an electric discharge gas space 28 in which a white fluorescent layer 27 is provided and electric discharge gas is encapsulated. As is the case with the backlight 2 of Embodiment 1, the electric discharge gas space 28 is a space inside the small tube, in which electric discharge gas is encapsulated. The plurality of plasma tubes 22 are provided, in an array, on the substrate 21 so as to from an array structure 23.

As illustrated in FIG. 8, the lower electrodes 24b, each having a strip shape, are made of a material having electrical conductivity, and are provided so that one (1) lower electrode 24b is provided for every three (3) plasma tubes 22. The upper transparent electrodes 25b are made of a transparent electrical conductive film such as ITO, and are provided so as to intersect with the plurality of plasma tubes 22. Each of the upper transparent electrodes 25 in the backlight 2 of Embodiment 1 has a width which is substantially the same as that of one (1) plasma tube 22, whereas each of the upper transparent electrodes 25b in the backlight 42 of Embodiment 3 has a width which is substantially the same as a summation of widths of three (3) plasma tubes 22 (that is, treble diameter of one (1) plasma tube 22). The lower electrodes 24b and the upper transparent electrodes 25b are provided so as to face each other via the plurality of plasma tubes 22.

In the backlight 42 thus arranged, it is the plurality of plasma tubes 22 that serve as light sources. The liquid crystal display panel 3 is irradiated by the light, emitted in each of the plurality of plasma tubes 22, which has transmitted the transparent substrate (not illustrated). Then, light thus passed through the transparent substrate irradiates. That is, a surface of the transparent substrate serves as the light emitting section 29 of the backlight 2.

The following description will discuss in more detail how the array structure 23 is arranged in which the plurality of plasma tubes 22 are provided in an array.

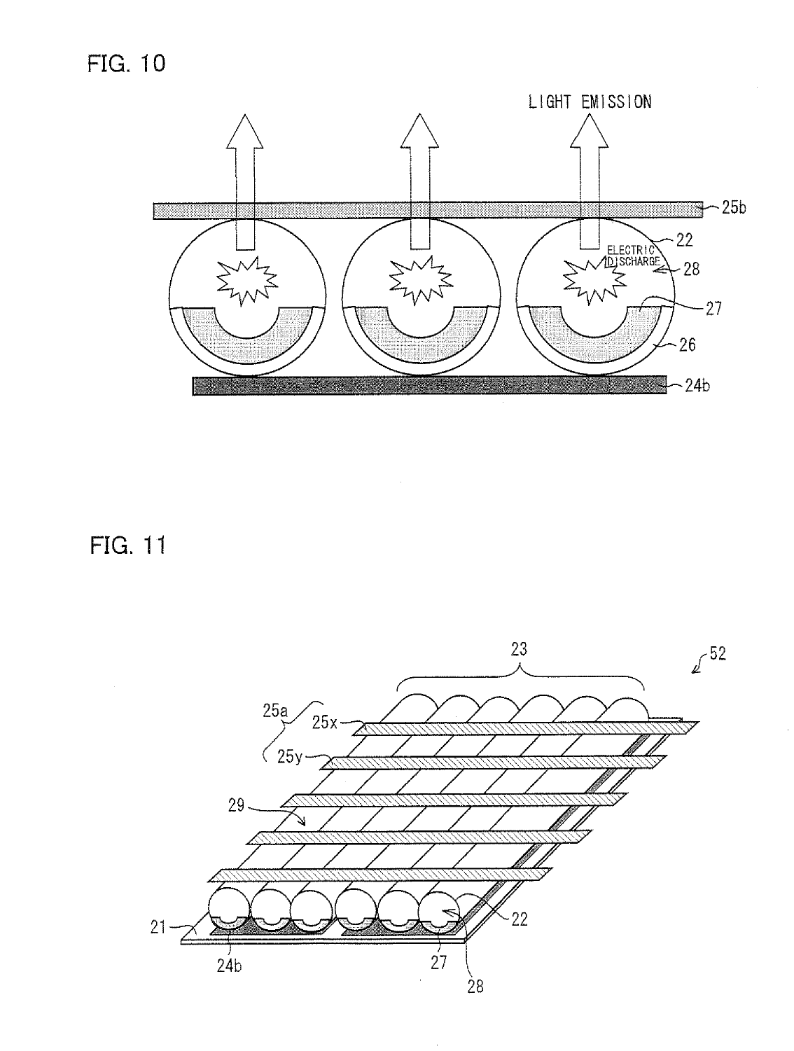

FIG. 9 is a two-dimensional view of the array structure 23 as seen from the light emitting section 29 side (that is, as seen from a side on which the upper transparent electrodes 25 are provided). FIG. 10 is a cross-sectional view taken along the line A-A′ of the array structure 23 of FIG. 9.

As illustrated in FIG. 9, the plurality of plasma tubes 22 are provided in an array. Further, the lower electrodes 24 (not illustrated), each having a strip shape, are provided in the longitudinal direction of the plurality of the plasma tubes 22, under the plurality of plasma tubes 22 (that is, on a side farther from the liquid crystal display panel 3). Furthermore, on the plurality of plasma tubes 22 (that is, on a side closer to the liquid crystal display panel 3), the upper transparent electrodes 25b, each having a strip shape, are provided so as to intersect with the longitudinal direction of the plurality of the plasma tubes 22. The lower electrodes 24b and the upper transparent electrodes 25b are thus provided so as to intersect with each other via the plurality of plasma tubes 22.

Moreover, a support member 26 is provided in each of the plurality of plasma tubes 22 so that the white fluorescent layer 27 is provided on the support member 26 (see FIG. 10). The electric discharge gas is introduced in each of the plurality of plasma tubes 22, and each of the plurality of plasma tubes 22 is end-sealed at both ends. This causes the electric discharge gas space 28 to be formed in each of the plurality of plasma tubes 22. As described above, according to the present embodiment, the plurality of plasma tubes 22, each having a white fluorescent member and emitting white light, are employed as the light sources.

In each of the plurality of plasma tubes 22, electric discharge occurs around each of the intersections of the lower electrodes 24b and the upper transparent electrodes 25b in response to voltages applied between one of the lower electrodes 24b and corresponding ones of the upper transparent electrodes 25b (see FIG. 9, which is a two-dimensional view of the backlight 2 as seen from above). In this way, each of the plurality of plasma tubes 22 emits light. The light thus emitted from inside each of the plurality of plasma tubes 22 transmits a corresponding one of the upper transparent electrodes 25b, and is then directed from the light emitting section 29 toward the liquid crystal display panel 3 (see FIG. 10).

As described above, the backlight 42 of Embodiment 3 is arranged such that the electric discharge occurs inside each of the plurality of plasma tubes 22 in each of regions between the lower electrodes 24b and the upper transparent electrodes 25b (that is, the electric discharge occurs directly below each of the upper transparent electrodes 25b). As such, unit light-emitting regions R3 correspond to the respective intersections of the lower electrodes 24 and the upper transparent electrodes 25 (see a region indicated by dashed square in FIG. 9) which are provided so as to intersect with each other in a lattice manner. For example, in a case of using plasma tubes each having a diameter of 1 mm, a size of each of the unit light-emitting regions R3 is to be 3 mm×3 mm.

Under the circumstances, it is possible to control a light-emitting state of the respective unit light-emitting regions R3, in a case where (i) ones of the lower electrodes 24b and the upper transparent electrodes 25b serve as scanning electrodes and (ii) the other ones of the lower electrodes 24b and the upper transparent electrodes 25b serve as signal electrodes for controlling voltages to be applied between one of the lower electrodes 24b and the upper transparent electrodes 25b.

More specifically, it is possible to adjust luminance of light emitted from each of the unit light-emitting regions R3, in a case where the backlight 42 includes a drive circuit (drive section) that is capable of controlling, for the respective unit light-emitting regions R3, voltages to be applied between the lower electrodes 24b an the upper transparent electrodes 25b. This makes it possible to achieve an area active backlight.

Moreover, according to Embodiment 3, both the lower electrodes 24b and the upper transparent electrodes 25b are arranged so as to have respective larger widths than those in the arrangement of Embodiment 1. Therefore, each of the unit light-emitting regions R3 is larger in area. For example, according to FIG. 9, each of the unit light-emitting regions R3 has a width that is equal to the summation of widths of three plasma tubes 22. However, the width of each of the unit light-emitting regions R3 is not necessarily limited to the above width, and therefore can be a width that is equal to a summation of widths of a plurality of plasma tubes 22 (the number other than three), if needed. The present invention can also be arranged such that one (1) lower electrode is provided for every predetermined number of plasma tubes.

### Embodiment 4

The fourth embodiment of the present invention is described below with reference to the attached drawings.

The fourth embodiment will describe a liquid crystal display device including a backlight arranged such that, as is the case with Embodiment 3, a lower electrode is provided for every predetermined number of plasma tubes (for example, for every three plasma tubes), and that, as is the case with Embodiment 2, (i) electrodes provided on a light emitting section 29 side of the plurality of plasma tubes 22 constitute electrode pairs 25a (each of which is constituted by a pair of electrodes 25x and 25y) and (ii) electric discharge occurs in response to voltages applied between each of the electrode pairs 25a and the lower electrodes 24b.

A liquid crystal display device 1 of the present embodiment has an arrangement similar to that of the liquid crystal display device 1 of FIG. 2. Therefore, a description of the liquid crystal display 1 of the present embodiment is omitted here. It should be noted in the following descriptions that members having structures similar to those of the liquid crystal display device 1 of Embodiment 1 are given the same reference numerals, and descriptions of the members are omitted as appropriate.

Next, a backlight 52 included in the liquid crystal display device 1 of Embodiment 4 is described below. FIG. 11 illustrates how the backlight 32 is arranged.

As illustrated in FIG. 11, the backlight 52 mainly includes: a substrate 21 for supporting plasma tubes; a plurality of plasma tubes 22 (light sources) in each of which electric discharge gas is encapsulated; lower electrodes 24b (first electrodes) which are used for light emission use and are provided between the substrate 21 and the plurality of plasma tubes 22; and upper electrode pairs 25a (second electrodes) which face the lower electrodes 24b via the plurality of plasma tubes 22. The backlight 52 further includes a transparent substrate (not illustrated) on a light emitting section 29 side.

As is the case with the backlight 2 of Embodiment 2, the plurality of plasma tubes 22 are provided, in an array, on the substrate 21 so as to form an array structure 23. Further, as is the case with Embodiment 3, the lower electrodes 24b, each having a strip shape, are made of a material having electrical conductivity, and are provided so that one (1) lower electrode 24b is provided for every three plasma tubes 22 (see FIG. 11). As is the case with Embodiment 2, each of the upper electrode pairs 25a provided on the light emitting section 29 side is constituted by two (2) electrodes, i.e., an electrode 25x and an electrode 25y each having a strip shape.

In the backlight 52 thus arranged, it is the plurality of plasma tubes 22 that serve as light sources. The liquid crystal display panel 3 is irradiated by the light, emitted in each of the plurality of plasma tubes 22, which has transmitted the transparent substrate (not illustrated). Then, light thus passed through the transparent substrate irradiates. That is, a surface of the transparent substrate serves as the light emitting section 29 of the backlight 32.

The following description discusses in more detail as to how the array structure 23, in which the plurality of plasma tubes 22 are provided in an array.

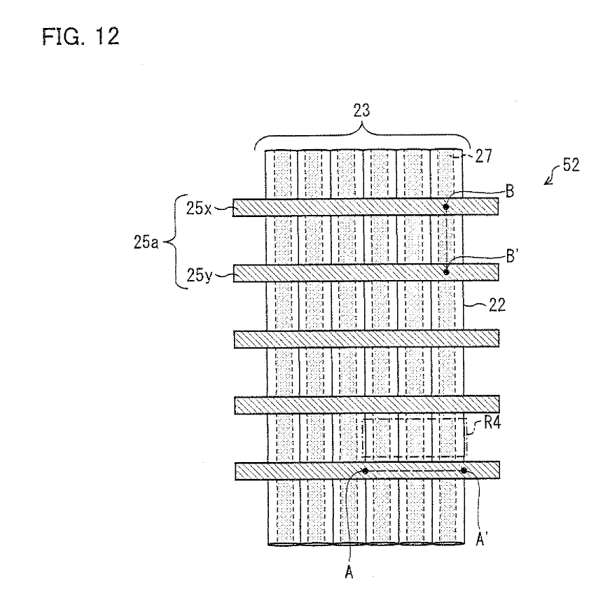

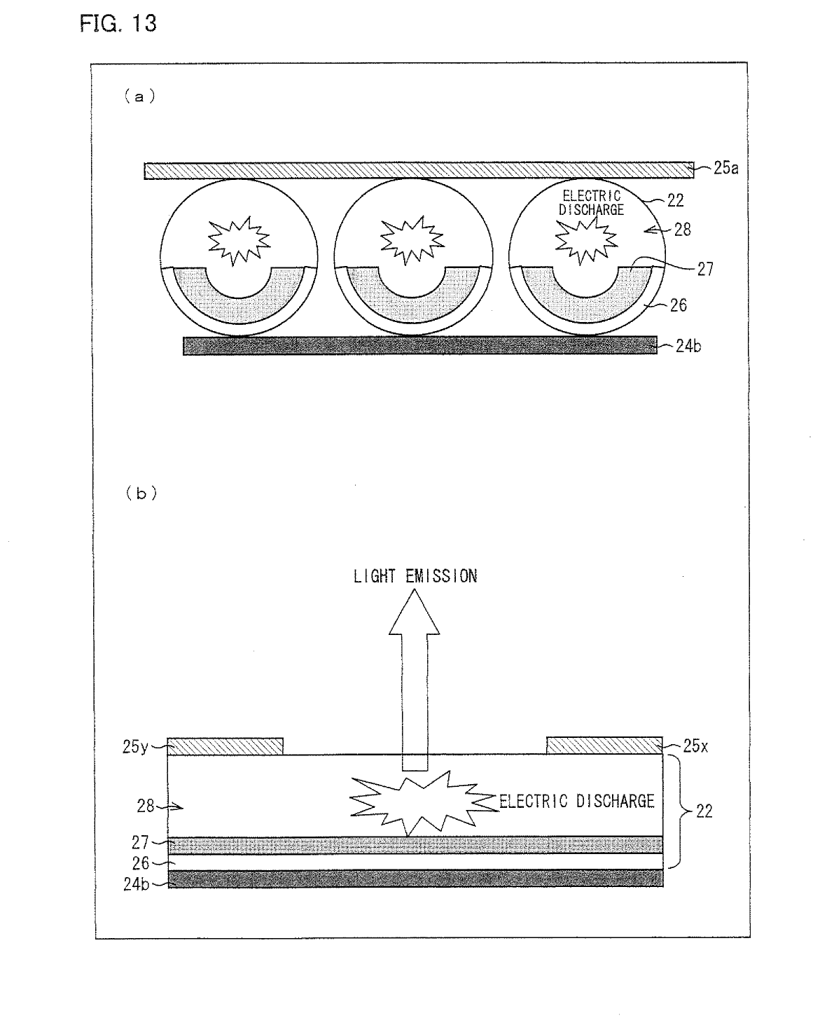

FIG. 12 is a two-dimensional view of the array structure 23 as seen from the light emitting section 29 side (that is, as seen from a side on which the upper transparent electrodes 25a are seen). (a) of FIG. 13 is a cross-sectional view taken along the line A-A′ of the array structure 23 of FIG. 12. (b) of FIG. 13 is a cross-sectional view taken along the line B-B′ of the array structure 23 of FIG. 12.

As illustrated in FIG. 12, the plurality of plasma tubes 22 are provided in an array. Further, the lower electrodes 24b (not illustrated), each having a strip shape, are provided in the longitudinal direction of the plurality of the plasma tubes 22, under the plurality of plasma tubes 22 (that is, on a side farther from the liquid crystal display panel 3). Furthermore, on the plurality of plasma tubes 22 (that is, on a side closer to the liquid crystal display panel 3), the upper electrode pairs 25a, each of which is constituted by the electrodes 25x and 25y, are provided so as to intersect with the longitudinal direction of the plurality of plasma tubes 22. The lower electrodes 24b and the upper electrode pairs 25a are thus provided so as to intersect with each other via the plurality of plasma tubes 22.

Moreover, a support member 26 is provided in each of the plurality of plasma tubes 22 so that the white fluorescent layer 27 is provided on the support member 26 (see (a) of FIG. 13). The electric discharge gas is introduced in each of the plurality of plasma tubes 22, and each of the plurality of plasma tubes 22 is end-sealed at both ends. This causes the electric discharge gas space 28 to be formed in each of the plurality of plasma tubes 22. As described above, according to the present embodiment, the plurality of plasma tubes 22, each having a white fluorescent member and emitting white light, are employed as the light sources.

As illustrated in (a) and (b) of FIG. 13, the backlight 52 of Embodiment 4 is arranged such that electric charge occurs, in each of the plurality of plasma tubes 22, (i) between a corresponding one of the upper electrode pairs 25a and a corresponding one of the lower electrodes 24 and (ii) between electrodes 25x and 25y which constitute the upper electrode pairs 25a.

According to the above-described arrangement, in each of the plurality of plasma tubes 22, electric discharge occurs, in response to voltages applied between one of the lower electrodes 24 and corresponding ones the upper electrode pairs 25a, around regions where (i) the corresponding one of the lower electrodes 24 and (ii) gaps between the electrodes 25x and the electrodes 25y of the upper electrode pairs 25a intersect with each other (see FIG. 12, which is a two-dimensional view of the backlight 2 as seen from above). In this way, the plurality of plasma tubes 22 emit light. The light thus emitted in each of the plurality of plasma tubes 22 transmits the gaps between the electrodes 25x and the electrodes 25y which constitute the upper electrode pairs 25a, and is then directed from the light emitting section 29 toward the liquid crystal display panel 3 (see (b) of FIG. 12).

In the above arrangement, a display is carried out by (1) generating a selective electric discharge at an intersection of a pair of display electrodes 25x and 25y and a corresponding one of the data electrodes (lower electrodes 24b) so that ultraviolet radiation is emitted inside a corresponding one of the plurality of luminous tubes, and then (ii) causing the ultraviolet radiation to excite a fluorescent material provided on a surface in the corresponding one of the plurality of luminous tubes of the intersection so that visible light is emitted. The display is thus carried out. The intensity (luminance) of the visible light thus emitted is controlled by changing voltages according to signals that are transmitted to the data electrodes.

In such a case, the unit light-emitting regions R4 correspond to the respective intersections of the lower electrodes 24 and the upper electrode pairs 25a (see a region indicated by dashed square in FIG. 12). For example, in a case of using plasma tubes each having a diameter of 1 mm, a size of each of the unit light-emitting regions R4 is to be 3 mm×1 mm.

Further, it is possible to control luminance of light emitted from each of the unit light-emitting regions R4, in a case where the backlight 52 includes a drive circuit (drive section) that is the same as that described in Embodiment 2. This makes it possible to achieve an area active backlight.

For example, according to FIG. 12, each of the unit light-emitting regions R4 has a width that is equal to the summation of widths of three plasma tubes 22. However, the width of each of the unit light-emitting regions R4 is not necessarily limited to the above width, and therefore can be a width that is equal to a summation of widths of a plurality of plasma tubes 22 (the number other than three), if needed. The present invention can also be arranged such that one (1) lower electrode is provided for every predetermined number of plasma tubes.

The invention is not limited to the embodiments, but can be altered within the scope of the claims set forth later. An embodiment derived from a proper combination of technical means disclosed in the different embodiments is also encompassed in the technical scope of the present invention.

As so far described, a liquid crystal display device according to the present invention includes: a liquid crystal display panel and a backlight, the backlight including a plurality of plasma tubes, and the plurality of plasma tubes being provided behind the liquid crystal display panel.

According to the present invention, the light sources are provided behind the liquid crystal display panel. As such, it is possible to achieve a liquid crystal display device (i) in which a liquid crystal panel is irradiated with light of high luminance and (ii) which is thinner. Further, according to the present invention, plasma tubes serve as light sources of a backlight. As such, it is possible to keep display fineness at least as good as that of a conventional display device.

The embodiments discussed in the foregoing description of embodiments and concrete examples serve solely to illustrate the technical details of the present invention, which should not be narrowly interpreted within the limits of such embodiments and concrete examples, but rather can be applied in many variations within the spirit of the present invention, provided that such variations do not exceed the scope of the patent claims set forth below.

### INDUSTRIAL APPLICABILITY

The present invention makes it possible to achieve a thinner liquid crystal display device including a backlight that is capable of uniformly irradiating a liquid crystal display panel. As such, the liquid crystal display device of the present invention is suitably applicable for use in a display device that is required to carry out a high-definition image display.

1. A liquid crystal display device, comprising a liquid crystal display panel and a backlight,
the backlight including a plurality of plasma tubes serving as light sources, in each of the plasma tubes (i) a fluorescent material being included and (ii) electric discharge gas being encapsulated, and
the plurality of plasma tubes being provided behind the liquid crystal display panel.

2. The liquid crystal display device according to claim 1, wherein:
the backlight has (i) a substrate and (ii) an array structure in which the plurality of plasma tubes are provided on the substrate; and
the array structure has a first surface serving as a light emitting section that irradiates the liquid crystal display panel with light, the first surface being opposite to a second surface which faces the substrate.

3. The liquid crystal display device according to claim 2, wherein:
the array structure includes (i) a plurality of first electrodes that are provided in a direction in which the plurality of plasma tubes are provided and (ii) a plurality of second electrodes that are provided so as to intersect with the plurality of plasma tubes; and
the plurality of first electrodes and the plurality of second electrodes are provided so as to face each other via the plurality of plasma tubes.

4. The liquid crystal display device according to claim 3, wherein:
the plurality of first electrodes are provided so that one (1) first electrode is provided for every at least one plasma tube; and
the plurality of second electrodes are provided in an array so as to intersect with the plurality of plasma tubes.

5. The liquid crystal display device according to claim 4, wherein:
the plurality of first electrodes and the plurality of second electrodes, which are provided so as to (i) intersect with each other and (ii) face each other via the plurality of plasma tubes, form intersections in which respective unit light-emitting regions are provided,
said backlight including a drive section that can adjust, for each of the unit light-emitting regions, luminance of the light emitted from the light emitting section.

6. The liquid crystal display device according to claim 1, wherein the plurality of plasma tubes include a plasma tube having a white fluorescent material.

7. The liquid crystal display device according to claim 1, wherein the plurality of plasma tubes include a plasma tube having a red fluorescent material, a plasma tube having a green fluorescent material, and a plasma tube having a blue fluorescent material.

8. The liquid crystal display device according to claim 1, wherein:
the backlight has (i) a/the substrate and (ii) an/the array structure in which the plurality of plasma tubes are provided on the substrate; and
the array structure has a/the first surface serving as a/the light emitting section that irradiates the liquid crystal display panel with light, the first surface being opposite to a/the second surface which faces the substrate; and
the substrate is made of a flexible material.
